(19) United States
(12) Patent Application Publication
(10) Pub. No.: US 2025/0076807 A1
(43) Pub. Date: Mar. 6, 2025

(54) IMAGE FORMATION SYSTEM, IMAGE FORMATION APPARATUS, STATIC ELIMINATION APPARATUS, AND NON-TRANSITORY COMPUTER-READABLE STORAGE MEDIUM

(71) Applicant: CANON KABUSHIKI KAISHA, Tokyo (JP)

(72) Inventor: TAKESHI OKADA, Tokyo (JP)

(21) Appl. No.: 18/816,671

(22) Filed: Aug. 27, 2024

(30) Foreign Application Priority Data
Sep. 1, 2023 (JP) 2023-141950

(51) Int. Cl. G03G 15/00; B65H 29/14

(52) U.S. Cl. CPC G03G 15/6573; B65H 29/14; G03G 15/5079; B65H 2515/70

(57) ABSTRACT

An image formation system includes an image formation apparatus and a static elimination apparatus that performs static elimination of a sheet on which an image is formed by the image formation apparatus. The static elimination apparatus includes a conveyance unit that conveys the sheet, a static elimination unit that performs the static elimination of the sheet conveyed by the conveyance unit, and a signal transmission unit that transmits a certain signal based on a state of the static elimination unit. The image formation apparatus includes a signal reception unit that receives the signal transmitted by the signal transmission unit and a first notification unit that indicates content of notification corresponding to the signal received by the signal reception unit.

### BACKGROUND OF THE INVENTION

### Field of the Invention

The present disclosure relates to an image formation system including a static elimination apparatus that performs static elimination of a recording medium output from an image formation apparatus.

### Description of the Related Art

An image formation apparatus described in Japanese Patent Laid-Open No. 2009-15168 includes multiple static elimination units and a high-voltage power supply unit that supplies electric power to the static elimination units. Abnormality may occur in the static elimination units due to adhesion of toner or the like. If any abnormality of the static elimination unit is detected, the output from the high-voltage power supply unit having highest output is decreased and it is determined whether the abnormality occurs in the static elimination unit to which the electric power is supplied from the high-voltage power supply unit. Then, a user is notified of the result of determination and is caused to perform cleaning or the like. If it is determined that no abnormality occurs, the output from the high-voltage power supply unit having next highest output is decreased.

The image formation apparatus described in Japanese Patent Laid-Open No. 2009-15168 includes the static elimination units and notifies the user of any abnormality of the static elimination unit with a display unit of the image formation apparatus.

In an image formation apparatus, such as a copier, a printer, or a facsimile, which uses an electrophotographic method or an electrostatic recording method, sheets (a recording medium) may be charged in formation of an image and the sheets may be sticked or poor loading may occur due to electrostatic force occurring between the ejected sheets. Accordingly, an image formation system is proposed, which includes an image formation apparatus and a static elimination apparatus that performs static elimination of sheets on which images are formed by the image formation apparatus.

In the above image formation system, the state of the static elimination unit in the static elimination apparatus and the content of required supports and so on are not indicated on the image formation apparatus. Accordingly, it is difficult for a user who is working near the image formation apparatus to notice any maintenance required in the static elimination unit. As a result, the sheets on which the images are formed may not be subjected to the static elimination to cause the sticking of sheets or the poor loading. If the sheets are sticked, the sheets may not be conveyed successfully when the sheets are conveyed and processed in another sheet processing apparatus.

### SUMMARY OF THE INVENTION

The disclosure of the present application is intended to more desirably perform the maintenance of the static elimination unit.

In order to resolve the above problem, the present disclosure provides an image formation system having the following configuration.

The image formation system includes an image formation apparatus and a static elimination apparatus that performs static elimination of a sheet on which an image is formed by the image formation apparatus.

The static elimination apparatus includes a conveyance unit that conveys the sheet, a static elimination unit that performs the static elimination of the sheet conveyed by the conveyance unit, and a signal transmission unit that transmits a certain signal based on a state of the static elimination unit.

The image formation apparatus includes a signal reception unit that receives the signal transmitted by the signal transmission unit and a first notification unit that indicates content of notification corresponding to the signal received by the signal reception unit.

Further features of the present invention will become apparent from the following description of exemplary embodiments with reference to the attached drawings.

### BRIEF DESCRIPTION OF THE DRAWINGS

FIG. 1 is a mechanical cross-sectional view of an image formation apparatus in a first embodiment.

FIG. 2 is a schematic diagram of a static elimination apparatus in the first embodiment.

FIG. 3 is a block diagram illustrating system configurations of the image formation apparatus and the static elimination apparatus in the first embodiment.

FIG. 4 illustrates an example of a maintenance necessity notification setting window that is displayed to accept notification settings of maintenance necessity of the static elimination apparatus in the first embodiment.

FIG. 5A and FIG. 5B illustrate examples of maintenance necessity notification windows that are displayed to notify a user of the maintenance necessity of the static elimination apparatus in the first embodiment.

FIG. 6 is a list of messages describing the correspondence between the maintenance necessity of an ionizer, an opposing ionizer, a static elimination roller pair, and a high-voltage substrate in the first embodiment and the content of notification displayed in the image formation apparatus and the static elimination apparatus.

FIG. 7 is a flowchart describing a process of maintenance necessity notification performed by the static elimination apparatus in the first embodiment.

FIG. 8A and FIG. 8B are flowcharts describing a process of the maintenance necessity notification performed by the image formation apparatus in the first embodiment.

FIG. 9A illustrates an example of a maintenance required notification window in a second embodiment and FIG. 9B illustrates an example of a maintenance procedure notification window that is displayed to notify the user of the maintenance procedure of the static elimination apparatus in the second embodiment.

### DESCRIPTION OF THE EMBODIMENTS

Embodiments of the present disclosure will herein be described in detail with reference to the drawings. The embodiments described below are not intended to limit the disclosure according to the scope of the appended claims. Although multiple features are described in the embodiments, all the multiple features are not necessarily required for the disclosure and the multiple features may be arbitrarily combined. In addition, the same reference numerals are used in the drawings to identify the same or similar components and duplicated description of such components is omitted herein. Image formation apparatuses in the embodiments described below may be called multifunction apparatuses or multifunction peripherals (MFPs).

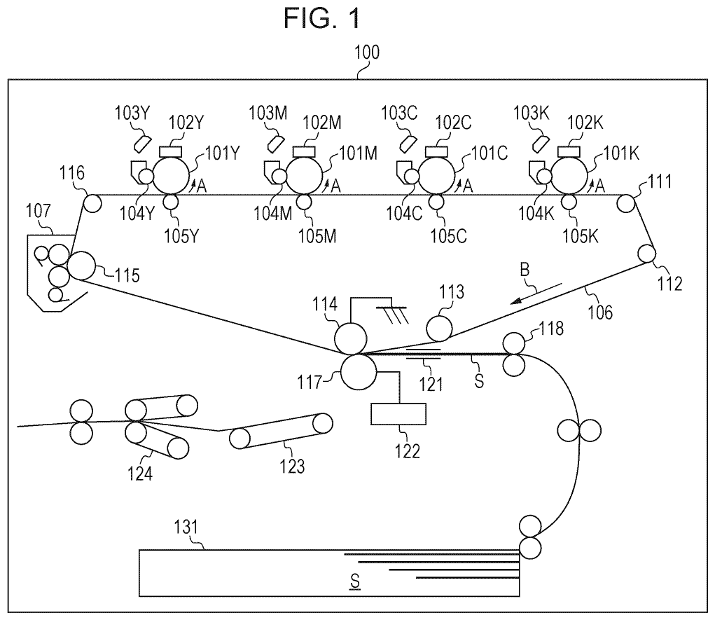

A first embodiment will now be described. An image formation system of the first embodiment includes an image formation apparatus 100 and a static elimination apparatus 200. FIG. 1 is a mechanical cross-sectional view of the image formation apparatus 100 in the first embodiment. The image formation apparatus 100 forms an image on a recording medium (hereinafter referred to as a sheet) using an electrophotographic process. As illustrated in FIG. 1, photoconductive drums (latent image bearing members) 101Y, 101M, 101C, and 101K rotate in a direction indicated by an arrow A. The surfaces of the photoconductive drums 101Y, 101M, 101C, and 101K are uniformly charged with charging devices 102Y, 102M, 102C, and 102K, respectively. The surfaces of the photoconductive drums 101Y, 101M, 101C, and 101K, which are uniformly charged, are exposed with exposure devices 103Y, 103M, 103C, and 103K, respectively, in accordance with image information to generate electrostatic latent images. Developing devices 104Y, 104M, 104C, and 104K develop the electrostatic latent images with toner of yellow (Y), magenta (M), cyan (C), and black (K), respectively, to form toner images on the surfaces of the photoconductive drums 101Y, 101M, 101C, and 101K. In the first embodiment, the developing devices 104Y, 104M, 104C, and 104K use a reversal development method of attaching the toner to exposure units of the electrostatic latent images for development.

Primary transfer rollers 105Y, 105M, 105C, and 105K are arranged so as to be opposed to the photoconductive drums 101Y, 101M, 101C, and 101K, respectively, with an intermediate transfer belt 106 interposed therebetween. With this configuration, the primary transfer rollers 105Y, 105M, 105C, and 105K form primary transfer nips (primary transfer units) between the intermediate transfer belt 106 and the photoconductive drums 101Y, 101M, 101C, and 101K. Transfer bias that has a polarity opposite to that of the toner images and that is subjected to constant voltage control is applied to the primary transfer rollers 105Y, 105M, 105C, and 105K in synchronization with the conveyance of the toner images of the respective colors on the surfaces of the photoconductive drums 101Y, 101M, 101C, and 101K to the respective primary transfer nips. As a result, the toner images on the surfaces of the respective photoconductive drums 101Y, 101M, 101C, and 101K are transferred on the intermediate transfer belt 106 (primary transfer). The intermediate transfer belt 106 rotates in a direction indicated by an arrow B to convey the transferred toner images to a secondary transfer nip.

The intermediate transfer belt 106 is arranged so as to abut against the surfaces of the photoconductive drums 101Y, 101M, 101C, and 101K. The intermediate transfer belt 106 rotates at a speed of 150 mm to 470 mm per second with being stretched by multiple stretching rollers 111, 112, 113, 114, 115, and 116. In the first embodiment, the stretching roller 112 is a tension roller that keeps the tension of the intermediate transfer belt 106 constant. The stretching roller 115 is a drive roller that drives the intermediate transfer belt 106. The stretching roller 114 is a secondary transfer inside roller.

A secondary transfer outside roller 117 is arranged so as to be opposed to the stretching roller 114 with the intermediate transfer belt 106 interposed therebetween. The secondary transfer outside roller 117 nips a sheet S with the secondary transfer nip (the secondary transfer unit) between the secondary transfer outside roller 117 and the intermediate transfer belt 106 for conveyance.

A feed tray 131 is a tray in which the sheets S are loaded and the sheet S loaded in the feed tray 131 is conveyed to a registration roller 118. The registration roller 118 conveys the sheet S to the secondary transfer nip in synchronization with the conveyance of the toner images on the intermediate transfer belt 106 to the secondary transfer nip. A before-secondary-transfer conveyance guide 121 improves the conveyance accuracy in the conveyance of the sheet S to the secondary transfer nip. A high-voltage applying unit 122 applies the transfer bias, which has a polarity opposite to that of the toner images and which is subjected to the constant voltage control, to the secondary transfer outside roller 117. The toner images on the intermediate transfer belt 106 are transferred to the sheet S (secondary transfer).

The sheet S on which the toner images are transferred is conveyed to a fixing apparatus 124 by a before-fixing conveyance device 123. The before-fixing conveyance device 123 loads the sheet S on its belt member that is rotating for conveyance. The fixing apparatus 124 applies heat and pressure to the sheet S to fix the toner images on the sheet S.

A belt cleaning device 107 electrostatically collects secondary transfer remaining toner on the intermediate transfer belt 106 for cleaning. The intermediate transfer belt 106 that is cleaned is repeatedly used for the formation of an image.

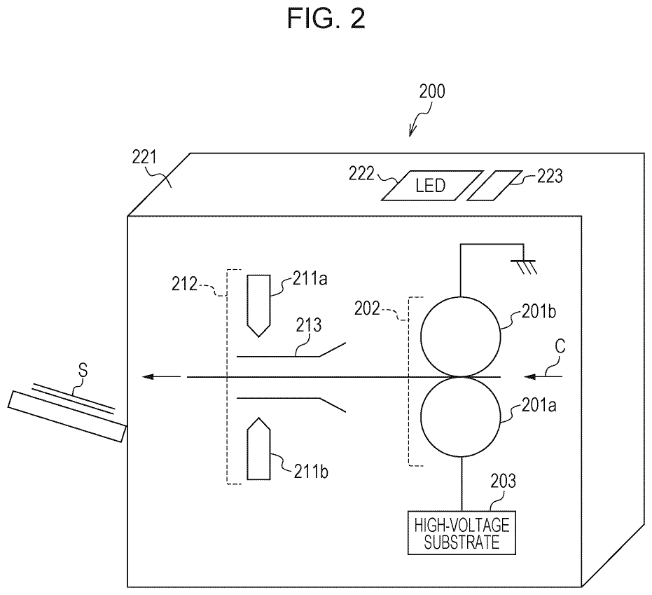

FIG. 2 is a schematic diagram of the static elimination apparatus 200 in the first embodiment. The static elimination apparatus 200 is arranged at the downstream side of the image formation apparatus 100 in a conveyance direction C of the sheets S. The static elimination apparatus 200 performs static elimination of the sheet S that is received from the image formation apparatus 100 and that is a medium to be subjected to the static elimination. The static elimination apparatus 200 may be directly connected to the image formation apparatus 100 or may be connected to the image formation apparatus 100 with a postprocessing apparatus, such as an inserter, interposed therebetween. The image formation apparatus 100 and the static elimination apparatus 200 operate with separate power supplies.

The static elimination apparatus 200 includes a frame body (casing) 221. The frame body 221 houses a static elimination roller pair 202, a high-voltage substrate 203, an ionizer pair 212, and a conveyance guide 213. The static elimination roller pair 202, the high-voltage substrate 203, and the ionizer pair 212 are an example of multiple static elimination units. The static elimination apparatus 200 includes at least one contact static elimination unit, such as the static elimination roller pair 202, and/or at least one non-contact static elimination unit, such as the ionizer pair 212.

The static elimination roller pair 202 includes a static elimination roller 201a and a static elimination opposing roller 201b arranged so as to be opposed to the static elimination roller 201a. The static elimination roller 201a and the static elimination opposing roller 201b are pressed into contact with each other to form a static elimination nip. The high-voltage substrate 203 generates high voltage and applies the high voltage to the static elimination roller 201a. The high voltage to be applied to the static elimination roller 201a has a polarity opposite to that of the voltage to be applied to the secondary transfer outside roller 117. The static elimination roller 201a and the static elimination opposing roller 201b perform the static elimination while nipping the sheet S in the static elimination nip. The static elimination roller pair 202 is also a conveyance unit that receives the sheet ejected from the image formation apparatus 100 and that conveys the received sheet.

In the first embodiment, the ionizer pair 212 is arranged at the downstream side of the static elimination roller pair 202 in the conveyance direction C. The ionizer pair 212 includes an ionizer 211a and an opposing ionizer 211b with the conveyance guide 213, which forms a conveyance path, sandwiched therebetween. The ionizer 211a is arranged above the conveyance guide 213 and the opposing ionizer 211b is arranged below the conveyance guide 213. The ionizer 211a is arranged so as to be opposed to the upper face (a first face) of the sheet S that is being conveyed. The opposing ionizer 211b is arranged so as to be opposed to the lower face (a second face), which is opposite to the upper face, of the sheet S that is being conveyed. The ionizer 211a and the opposing ionizer 211b of the first embodiment perform the static elimination of the sheet S using a corona discharge method in which alternating-current (AC) high voltage (alternating voltage) is applied to an electrode needle (a discharge needle) to alternately generate positive ion and negative ion. In the corona discharge method, the front surface and the rear surface of the sheet S is simultaneously subjected to the static elimination regardless of the polarity of the charge of the sheet S. The sheet S subjected to the static elimination is ejected to the outside of the static elimination apparatus 200. In the present specification and the drawings, the ionizer 211a may be referred to as an ionizer (upper) and the opposing ionizer 211b may be referred to as an ionizer (lower).

A light emitting diode (LED) 222 is an example of a second notification unit and indicates the states of the ionizer pair 212, the static elimination roller pair 202, and the high-voltage substrate 203 to a user by lighting and blinking. The LED 222 is arranged on an exterior of the frame body 221 so that the user is capable of confirming the content of display from the outside of the frame body 221. The second notification unit may be a display or may have a configuration notifying the user of the state not with the display but with sound as long as the second notification unit notifies the user of the states of the ionizer pair 212, the static elimination roller pair 202, and the high-voltage substrate 203.

An operation unit 223 accepts an instruction to perform or not to perform the static elimination operation and a setting of a high voltage output value output from the high-voltage substrate 203 from the user. The operation unit 223 is arranged on the exterior of the frame body 221 so that the user is capable of operating the operation unit 223 from the outside of the frame body 221.

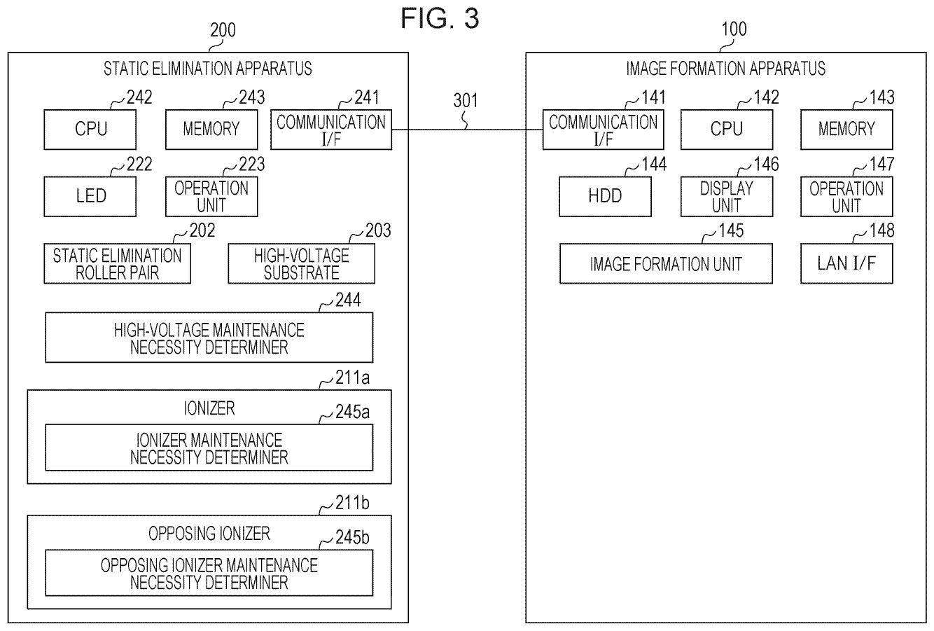

FIG. 3 is a block diagram illustrating system configurations of the image formation apparatus 100 and the static elimination apparatus 200 in the first embodiment.

First, the configuration of the image formation apparatus 100 will be described. The image formation apparatus 100 includes a communication interface (I/F) 141, a central processing unit (CPU) 142, a memory 143, a hard disk drive (HDD) 144, an image formation unit 145, a display unit 146, an operation unit 147, and a local area network (LAN) I/F 148. The communication I/F 141 is an example of a signal reception unit and is connected to the static elimination apparatus 200 via a communication cable 301 for communication required for control. The HDD 144 is a storage unit storing programs and data. The CPU 142 decomposes the programs stored in the HDD 144 into the memory 143 and executes the programs to comprehensively perform image processing and control of printing. The memory 143 stores the programs and image data, which are required by the CPU 142 to perform a variety of processing, and operates as a working area. The operation unit 147 accepts instructions of various settings and operations from the user. The display unit 146 is an example of a first notification unit and displays setup information concerning the image formation apparatus 100, the processing status of a print job, the state of the static elimination units, and so on. The image formation unit 145 forms an image on the sheet S through the operation described with reference to FIG. 1 based on an instruction from the CPU 142. The LAN I/F 148 is a communication interface enabling communication with an external information processing apparatus in a wired manner or wirelessly.

Next, the configuration of the static elimination apparatus 200 will be described. The static elimination apparatus 200 includes a communication I/F 241, a CPU 242, a memory 243, the LED 222, the operation unit 223, the static elimination roller pair 202, the high-voltage substrate 203, a high-voltage maintenance necessity determiner 244, the ionizer 211a, and the opposing ionizer 211b. The communication I/F 241 is an example of a signal transmission unit and is connected to the image formation apparatus 100 via the communication cable 301 for communication required for control. When the static elimination operation is instructed with the operation unit 223, the CPU 242 executes a control program stored in the memory 243 to perform a variety of control necessary for the static elimination. The static elimination roller pair 202, the high-voltage substrate 203, the ionizer 211a, and the opposing ionizer 211b perform the static elimination of the sheet S through the operation described with reference to FIG. 2 based on an instruction from the CPU 242.

The high-voltage maintenance necessity determiner 244 determines whether any abnormality occurs in the static elimination roller pair 202 and the high voltage output from the high-voltage substrate 203 based on an instruction from the CPU 242. If the difference between the high voltage output value from the high-voltage substrate 203 and the high voltage output value set with the operation unit 223 is higher than or equal to a predetermined value, the high-voltage maintenance necessity determiner 244 determines that high voltage output abnormality occurs. If the high-voltage maintenance necessity determiner 244 determines that high voltage output abnormality occurs, the CPU 242 stops the static elimination operation of the static elimination apparatus 200 and causes the static elimination apparatus 200 to perform only the conveyance of the sheet.

The ionizer 211a includes an ionizer maintenance necessity determiner 245a. The ionizer maintenance necessity determiner 245a determines whether cleaning of the ionizer 211a is required and whether any failure occurs in the ionizer 211a based on an instruction from the CPU 242. The opposing ionizer 211b includes an opposing ionizer maintenance necessity determiner 245b. The opposing ionizer maintenance necessity determiner 245b determines whether cleaning of the opposing ionizer 211b is required and whether any failure occurs in the opposing ionizer 211b based on an instruction from the CPU 242.

The determination of whether cleaning is required and whether any failure occurs is capable of being performed, for example, using the following method. The ionizer maintenance necessity determiner 245a determines that cleaning is required if supply voltage to the ionizer 211a is lower than a first threshold value. The ionizer maintenance necessity determiner 245a determines that any failure occurs if the supply voltage to the ionizer 211a is lower than a second threshold value lower than the first threshold value. The same applies to the opposing ionizer maintenance necessity determiner 245b.

The CPU 242 does not stop the static elimination operation of the static elimination apparatus 200 also if the ionizer maintenance necessity determiner 245a or the opposing ionizer maintenance necessity determiner 245b determines that cleaning is required. The CPU 242 stops the static elimination operation of the static elimination apparatus 200 and causes the static elimination apparatus 200 to perform only the conveyance of the sheet if the ionizer maintenance necessity determiner 245a or the opposing ionizer maintenance necessity determiner 245b determines that any failure occurs.

In addition, the CPU 242 lights up or blinks the LED 222 based on the results of determination by the high-voltage maintenance necessity determiner 244, the ionizer maintenance necessity determiner 245a, and the opposing ionizer maintenance necessity determiner 245b. The CPU 242 transmits a maintenance necessity signal including information about the results of determination to the image formation apparatus 100 via the communication I/F 241. The maintenance necessity signal enables the image formation apparatus to determine which maintenance is required in which static elimination unit. One maintenance necessity signal including the information about the results of determination by the multiple maintenance necessity determiners may be transmitted or multiple maintenance necessity signals including the information about the result of determination by one maintenance necessity determiner may be transmitted.

The CPU 142 in the image formation apparatus 100 displays a maintenance necessity message in the display unit 146 based on the maintenance necessity signal upon reception of the maintenance necessity signal from the static elimination apparatus 200.

The image formation apparatus 100 may have a configuration including a transmission unit (the LAN I/F 148) that converts the received maintenance necessity signal into a signal which the information processing apparatus connected to the image formation apparatus 100 via a network is capable of analyzing and that transmits the converted signal to the information processing apparatus. When the image formation apparatus 100 includes the transmission unit, it is possible to display the state of the static elimination apparatus also in the information processing apparatus used by the user to improve the user-friendliness.

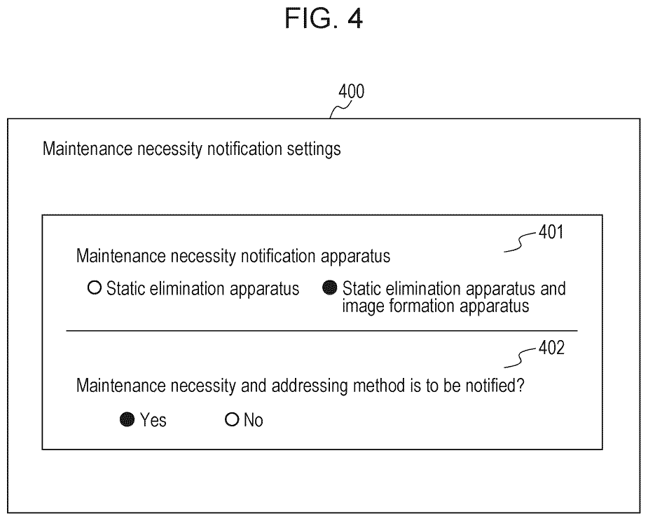

FIG. 4 illustrates an example of a maintenance necessity notification setting window 400 that is displayed to accept notification settings of the maintenance necessity of the ionizer pair 212, the static elimination roller pair 202, and the high-voltage substrate 203 in the first embodiment. Although the maintenance necessity notification setting window 400 is displayed in the display unit 146 in the image formation apparatus 100 in the first embodiment, a display unit that is an alternative to the LED 222 in the static elimination apparatus 200 may be provided and the maintenance necessity notification setting window 400 may be displayed in the display unit. In this case, the settings from the user may be accepted with the operation unit 223. The maintenance necessity notification setting window 400 includes a maintenance necessity notification apparatus setting 401 and an addressing method notification setting 402.

The maintenance necessity notification apparatus setting 401 is an example of a second acceptance unit and is an item for setting the apparatus to which the maintenance necessity of the ionizer pair 212, the static elimination roller pair 202, and the high-voltage substrate 203 is indicated. When the maintenance necessity notification apparatus setting 401 is set to “Static elimination apparatus”, the notification of the maintenance necessity is displayed in the LED 222 in the static elimination apparatus 200. When the maintenance necessity notification apparatus setting 401 is set to “Static elimination apparatus and image formation apparatus”, the notification of the maintenance necessity is displayed in the LED 222 in the static elimination apparatus 200 and the display unit 146 in the image formation apparatus 100.

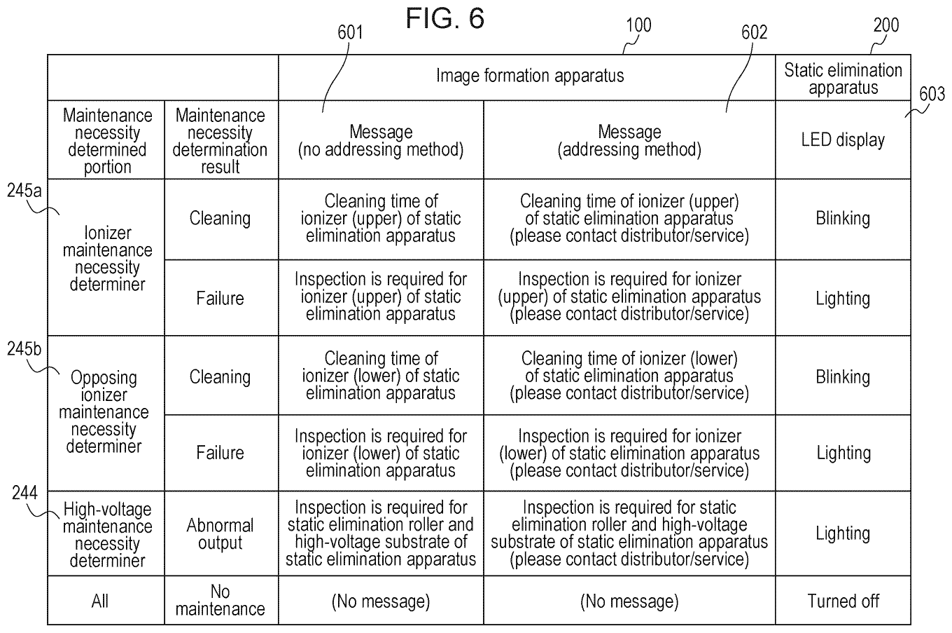

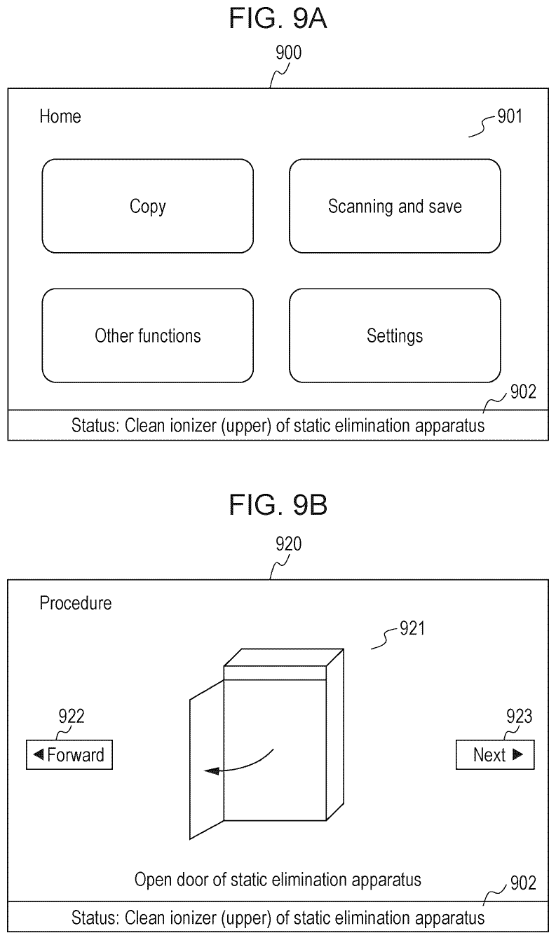

The addressing method notification setting 402 is an example of a first acceptance unit and is an item for indicating whether the maintenance necessity and the addressing method are to be displayed. When the addressing method notification setting 402 is set to “Yes”, the message of the maintenance necessity and the addressing method are displayed. The content of the addressing method to be displayed when the addressing method notification setting 402 is set to “Yes” may be a message instructing to contact a distributor/service of the static elimination apparatus 200 or the image formation apparatus 100 (FIG. 6) or may be a maintenance procedure (a second embodiment in FIG. 9).

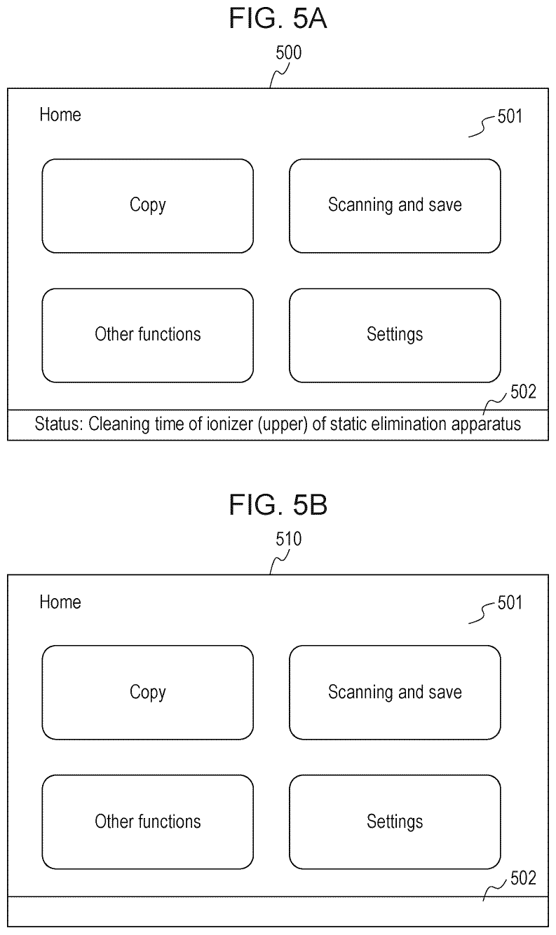

FIG. 5A and FIG. 5B illustrate examples of maintenance necessity notification windows that are displayed to notify the user of the maintenance necessity of the ionizer pair 212, the static elimination roller pair 202, and the high-voltage substrate 203 in the first embodiment. In the first embodiment, the display unit 146 and the operation unit 147 in the image formation apparatus 100 have an integrated configuration in which a touch operation of the user on the window displayed on the display is accepted as the instruction, and the maintenance necessity notification window is displayed on the display.

FIG. 5A illustrates a maintenance required notification window 500. The maintenance required notification window 500 includes an operation area 501 and a message area 502. An instruction of a certain operation or setting or the like to the image formation apparatus 100 is acceptable in the operation area 501. The states of the image formation apparatus 100 and the static elimination apparatus 200 are displayed in the message area 502. The maintenance necessity message based on the maintenance necessity signal received from the static elimination apparatus 200 is displayed in the message area 502. The maintenance required notification window 500 is an example of the window that is displayed when the ionizer maintenance necessity determiner 245a determines that cleaning is required. When multiple maintenance necessity messages are to be displayed, the display of the messages is switched for every certain time (for example, for every several seconds).

FIG. 5B illustrates a maintenance not-required notification window 510. The maintenance not-required notification window 510 is an example of the window that is displayed if it is determined that the maintenance is not required in all the maintenance necessity determiners. Displaying no message in the message area 502 indicates that the maintenance and the addressing are not required in the first embodiment.

FIG. 6 is a list of messages describing the correspondence between the maintenance necessity of the ionizer 211a, the opposing ionizer 211b, the static elimination roller pair 202, and the high-voltage substrate 203 in the first embodiment and the content of notification displayed in the image formation apparatus 100 and the static elimination apparatus 200.

A message (no addressing method) 601 is a column indicating a message displayed in the message area 502 when the maintenance necessity notification apparatus setting 401 is set to “Static elimination apparatus and image formation apparatus” and the addressing method notification setting 402 is set to “No”. The message is determined by a combination of the maintenance necessity determiner and a maintenance necessity determination result.

A message (addressing method) 602 is a column indicating a message displayed in the message area 502 when the maintenance necessity notification apparatus setting 401 is set to “Static elimination apparatus and image formation apparatus” and the addressing method notification setting 402 is set to “Yes”. In the example in FIG. 6, the message indicating that the maintenance is required is followed by a message of an addressing method (contact distributor/service) to be performed by the user. The message is determined by a combination of the maintenance necessity determiner and the maintenance necessity determination result.

An LED display 603 is a column indicating the display of the LED 222 for each maintenance necessity determination result by the high-voltage maintenance necessity determiner 244, the ionizer maintenance necessity determiner 245a, and the opposing ionizer maintenance necessity determiner 245b. Priority is given to lighting when the determination indicates that both blinking and lighting are performed (for example, in a case in which the high-voltage maintenance necessity determiner 244 determines that output abnormality occurs and the ionizer maintenance necessity determiner 245a determines that cleaning is required). Multiple LEDs 222 may be provided to display the maintenance necessities of the ionizer 211a, the opposing ionizer 211b, the static elimination roller pair 202, and the high-voltage substrate 203 on the respective multiple LEDs 222.

Although no message is displayed in the message area 502 and the LED 222 is turned off if it is determined that the maintenance is not required in all the maintenance necessity determiners in the first embodiment, the method of notifying the user of the unnecessity of the maintenance is not limited to this. For example, a message indicating that no abnormality occurs in the static elimination apparatus may be displayed in the message area 502 or the state of the static elimination apparatus, such as the time when the maintenance is required next, may be displayed in the message area 502. Alternatively, the state in which the maintenance is not required may be indicated by varying the lighting color, instead of turning-off of the LED 222.

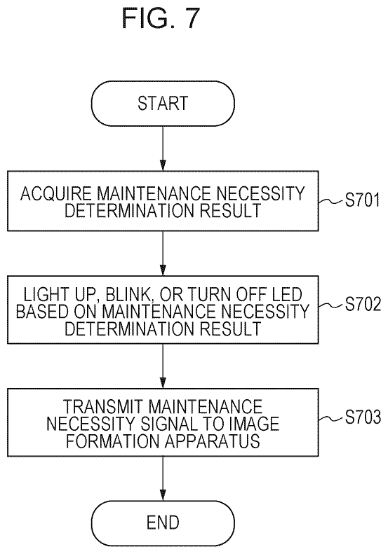

FIG. 7 is a flowchart describing a process of the maintenance necessity notification performed by the static elimination apparatus 200 in the first embodiment. A series of processing indicated in this flowchart is started at a timing when at least one of the high-voltage maintenance necessity determiner 244, the ionizer maintenance necessity determiner 245a, and the opposing ionizer maintenance necessity determiner 245b determines the maintenance necessity. The series of processing indicated in this flowchart is realized by the CPU 242 in the static elimination apparatus 200, which executes the control program stored in the memory 243.

Referring to FIG. 7, in Step S701, the CPU 242 acquires the maintenance necessity determination result of at least one of the high-voltage maintenance necessity determiner 244, the ionizer maintenance necessity determiner 245a, and the opposing ionizer maintenance necessity determiner 245b. After the maintenance necessity determination result is acquired, the process goes to Step S702.

In Step S702, the CPU 242 lights up, blinks, or turns off the LED 222 in accordance with the LED display 603 in FIG. 6 based on the maintenance necessity determination result acquired in Step S701. Then, the process goes to Step S703.

In Step S703, the CPU 242 generates the maintenance necessity signal from the maintenance necessity determination result acquired in Step S701 to transmit the maintenance necessity signal to the image formation apparatus 100 via the communication I/F 241. After the maintenance necessity signal is transmitted, the process in FIG. 7 is terminated.

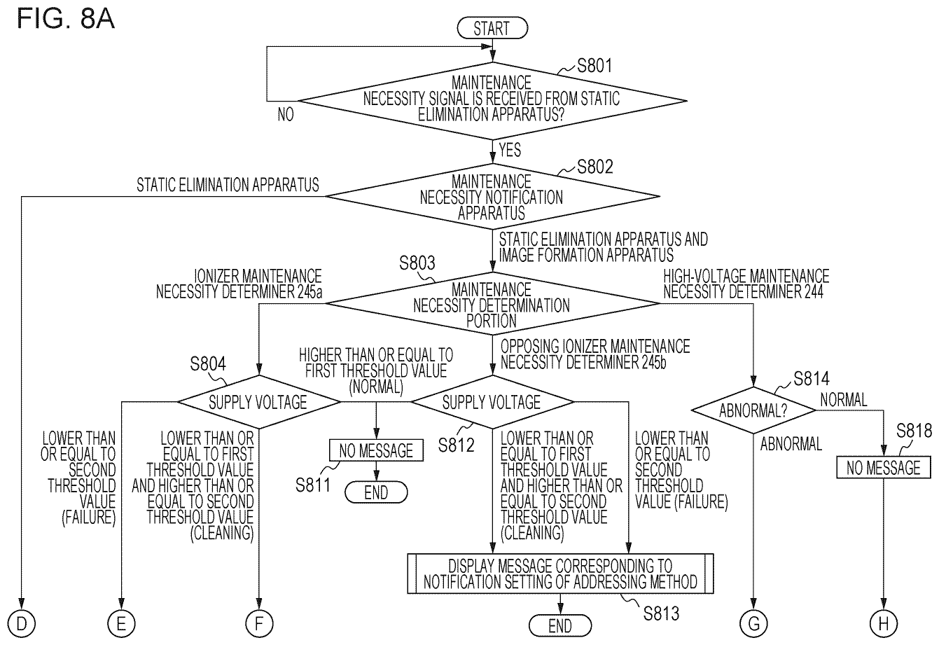

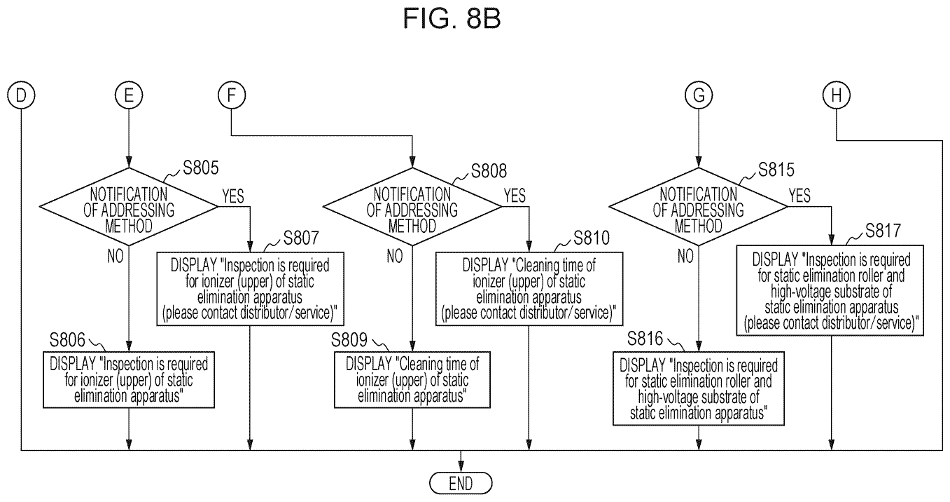

FIG. 8A and FIG. 8B are flowcharts describing a process of the maintenance necessity notification performed by the image formation apparatus 100 in the first embodiment. A series of processing indicated in this flowchart is realized by the CPU 142 in the image formation apparatus 100, which decomposes the control program stored in the HDD 144 into the memory 143 for execution.

Referring to FIG. 8A, in Step S801, the CPU 142 confirms whether the maintenance necessity signal from the static elimination apparatus 200 is received in Step S703. If the maintenance necessity signal is received, the process goes to Step S802.

In Step S802, the CPU 142 determines whether the maintenance necessity message based on the maintenance necessity signal received in Step S801 is to be displayed. If the maintenance necessity notification apparatus setting 401 is set to “Static elimination apparatus”, the CPU 142 determines that the maintenance necessity message is not to be displayed and, then, the process in FIG. 8A and FIG. 8B is terminated. If the maintenance necessity notification apparatus setting 401 is set to “Static elimination apparatus and image formation apparatus”, the CPU 142 determines that the maintenance necessity message is to be displayed and, then, the process goes to Step S803.

In Step S803, the CPU 142 identifies the maintenance necessity determination portion from the maintenance necessity signal received in Step S801. The process goes to Step S804 if the maintenance necessity determination portion is the ionizer maintenance necessity determiner 245a, goes to Step S812 if the maintenance necessity determination portion is the opposing ionizer maintenance necessity determiner 245b, and goes to Step S814 if the maintenance necessity determination portion is the high-voltage maintenance necessity determiner 244.

In Step S804, the CPU 142 identifies the state of the ionizer 211a from the maintenance necessity signal received in Step S801. If the supply voltage to the ionizer 211a is lower than or equal to the second threshold value (a failure of the ionizer 211a), the process goes to Step S805 in FIG. 8B. If the supply voltage to the ionizer 211a is higher than or equal to the second threshold value and lower than or equal to the first threshold value (cleaning of the ionizer 211a is required), the process goes to Step S808 in FIG. 8B. If the supply voltage to the ionizer 211a is higher than or equal to the first threshold value (the ionizer 211a is normal), the process goes to Step S811. In Step S811, no message is displayed and the process in FIG. 8A and FIG. 8B is terminated.

In Step S805, the CPU 142 determines the content of the message. If the addressing method notification setting 402 is set to “No”, the process goes to Step S806 in FIG. 8B. In Step S806, the message “Inspection is required for ionizer (upper) of static elimination apparatus” is displayed. If the addressing method notification setting 402 is set to “Yes”, the process goes to Step S807 in FIG. 8B. In Step S807, the message “Inspection is required for ionizer (upper) of static elimination apparatus (please contact distributor/service)” is displayed.

In Step S808, the CPU 142 determines the content of the message, as in Step S805. If the addressing method notification setting 402 is set to “No”, the process goes to Step S809 in FIG. 8B. In Step S809, the message “Cleaning time of ionizer (upper) of static elimination apparatus” is displayed. If the addressing method notification setting 402 is set to “Yes”, the process goes to Step S810 in FIG. 8B. In Step S810, the message “Cleaning time of ionizer (upper) of static elimination apparatus (please contact distributor/service)” is displayed.

Since the steps (Step S812 and the subsequent steps) when the determination portion is the opposing ionizer maintenance necessity determiner 245b are the same as those for the ionizer maintenance necessity determiner 245a, a description of the steps is omitted herein. Although the steps similar to Step S805 to Step S810 are performed in Step S813, the ionizer (upper) in the message is replaced with the ionizer (lower) (FIG. 6).

In Step S814, the CPU 142 identifies the states of the static elimination roller pair 202 and the high-voltage substrate 203 from the maintenance necessity signal received in Step S801. If any abnormality occurs (ABNORMAL), the process goes to Step S815 in FIG. 8B. If no abnormality occurs (NORMAL), the process goes to Step S818. In Step S818, no message is displayed and the process in FIG. 8A and FIG. 8B is terminated.

In Step S815, the CPU 142 determines the content of the message. If the addressing method notification setting 402 is set to “No”, the process goes to Step S816 in FIG. 8B. In Step S816, the message “Inspection is required for static elimination roller and high-voltage substrate of static elimination apparatus” is displayed. If the addressing method notification setting 402 is set to “Yes”, the process goes to Step S817 in FIG. 8B. In Step S817, the message “Inspection is required for static elimination roller and high-voltage substrate of static elimination apparatus (please contact distributor/service)” is displayed.

After the messages are displayed in Steps S806, S807, S809, S810, S816, and S817, the process in FIG. 8A and FIG. 8B is terminated.

The condition that the display of the message be terminated is exemplified by a case in which it is determined that the maintenance is not required, a case in which the power supply of the static elimination apparatus is turned off and is turned on again, and so on.

A second embodiment will now be described. A description of points common to the first embodiment is omitted herein. It is supposed that the user performs the maintenance in the second embodiment. The second embodiment differs from the first embodiment in the window that is displayed in the display unit 146 in the image formation apparatus 100 if the addressing method notification setting 402 is set to “Yes”. When a display unit that is an alternative to the LED 222 is provided in the static elimination apparatus 200, the window may be displayed in the display unit in the static elimination apparatus 200.

FIG. 9A illustrates a maintenance required notification window 900 that is displayed in the display unit 146 if the ionizer maintenance necessity determiner 245a determines that cleaning is required and the addressing method notification setting 402 is set to “Yes” (Yes in Step S808 in FIG. 8B). The maintenance required notification window 900 includes an operation area 901 and a message area 902, as in the maintenance required notification window 500. The message “Clean ionizer (upper) of static elimination apparatus” is displayed in the message area 902 in FIG. 9A.

FIG. 9B illustrates a maintenance procedure notification window 920 that is displayed upon touch of the message area 902 in FIG. 9A by the user. Illustration and a text describing a maintenance procedure is indicated in a maintenance procedure 921. A Forward button 922 is a button with which a display instruction of a previous procedure of the procedure displayed in the maintenance procedure 921 is accepted. A Next button 923 is a button with which a display instruction of a next procedure of the procedure displayed in the maintenance procedure 921 is accepted.

Although the forward procedure or the next procedure is displayed upon depression of the Forward button 922 or the Next button 923 by the user in the second embodiment, a configuration may be adopted in which the maintenance procedure 921 is automatically switched.

For example, a configuration may be adopted in which the CPU 242 detects the progress of maintenance and transmits a signal indicating the progress of the maintenance to the image formation apparatus 100 via the communication I/F 241 (a progress-of-maintenance transmission unit) and the communication I/F 141 (a progress-of-maintenance reception unit) and the maintenance procedure 921 is switched based on the information received by the CPU 142.

The maintenance procedure displayed in the maintenance procedure 921 may include turning-off of the static elimination apparatus before the maintenance, the way to use tools used for the maintenance, and start-up of the static elimination apparatus after the maintenance. Since the maintenance procedure notification window 920 is displayed in the display unit 146 in the image formation apparatus 100 even when the static elimination apparatus 200 is turned off before the maintenance according to the second embodiment, it is possible for the user to perform the work while referring to the maintenance procedure even without a paper manual or the like.

As described above, according to the first embodiment and the second embodiment, the state of the static elimination unit in the static elimination apparatus is displayed in the display unit of the image formation apparatus to notify the user of the state. Accordingly, the user who is working near the image formation apparatus is capable of rapidly being aware of any abnormality of the static elimination unit to address the abnormality.

### Other Embodiments

The present disclosure is capable of being realized by supplying the programs realizing one or more functions of the above embodiments to a system or an apparatus via a network or a recording medium and reading the programs by one or more processors in a computer in the system or the apparatus for execution. The present disclosure is also capable of being realized by a circuit (for example, an application specific integrated circuit (ASIC)) realizing one or more functions.

According to the present disclosure, the notification of the state of the static elimination unit in the image formation apparatus enables the user to rapidly be aware of a state in which the maintenance is required in the static elimination unit to address the problem before sticking or poor loading occurs.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-141950, filed Sep. 1, 2023, which is hereby incorporated by reference herein in its entirety.

What is claimed is:

1. An image formation system comprising:
an image formation apparatus; and
a static elimination apparatus configured to perform static elimination of a sheet on which an image is formed by the image formation apparatus,
wherein the static elimination apparatus includes
a conveyance unit that conveys the sheet,
a static elimination unit that performs the static elimination of the sheet conveyed by the conveyance unit, and
a signal transmission unit that transmits a certain signal based on a state of the static elimination unit, and
wherein the image formation apparatus includes
a signal reception unit that receives the signal transmitted by the signal transmission unit, and
a first notification unit that indicates content of notification corresponding to the signal received by the signal reception unit.

2. The image formation system according to claim 1,
wherein the static elimination apparatus includes a plurality of static elimination units, and
wherein the content of notification indicates which maintenance is required in which static elimination unit.

3. The image formation system according to claim 1,
wherein the static elimination apparatus includes a plurality of static elimination units, and
wherein the first notification unit switches the content of notification for every certain time for notification in notification of a state of the plurality of static elimination units.

4. The image formation system according to claim 1,
wherein a state of the static elimination unit is a state in which maintenance for the static elimination unit is required.

5. The image formation system according to claim 1,
wherein the image formation apparatus includes a transmission unit that transmits a state of the static elimination unit to an information processing apparatus connected to the image formation apparatus via a network.

6. The image formation system according to claim 1,
wherein the static elimination apparatus includes a non-contact static elimination unit that performs the static elimination of the sheet conveyed by the conveyance unit in a non-contact manner as the static elimination unit.

7. The image formation system according to claim 6,
wherein the non-contact static elimination unit is an ionizer.

8. The image formation system according to claim 1,
wherein the static elimination apparatus includes a contact static elimination unit that performs the static elimination of the sheet conveyed by the conveyance unit in a contact manner as the static elimination unit.

9. The image formation system according to claim 1,
wherein the content of notification by the first notification unit includes a maintenance procedure of the static elimination unit.

10. The image formation system according to claim 9,
wherein the maintenance procedure includes a way to use tools used for the maintenance of the static elimination unit.

11. The image formation system according to claim 9,
wherein the maintenance procedure includes turning-off of the static elimination apparatus.

12. The image formation system according to claim 9,
wherein the maintenance procedure includes start-up of the static elimination apparatus.

13. The image formation system according to claim 9,
wherein the maintenance procedure includes turning-off of the static elimination apparatus before maintenance, a way to use tools used for the maintenance of the static elimination unit, and start-up of the static elimination apparatus after maintenance.

14. The image formation system according to claim 9,
wherein the static elimination apparatus includes a progress-of-maintenance transmission unit that transmits a certain signal based on progress of the maintenance procedure,
wherein the image formation apparatus includes a progress-of-maintenance reception unit that receives the signal transmitted from the progress-of-maintenance transmission unit, and
wherein the maintenance procedure corresponding to the signal received by the progress-of-maintenance reception unit is notified with the first notification unit.

15. The image formation system according to claim 1,
wherein the image formation apparatus includes a first acceptance unit that accepts a setting indicating whether an addressing method is included in the content notified by the first notification unit.

16. The image formation system according to claim 1,
wherein the static elimination apparatus includes a second notification unit, and
wherein the image formation apparatus includes a second acceptance unit that accepts a setting indicating whether the content of notification based on maintenance necessity to the static elimination unit is notified by the second notification unit or is notified by the second notification unit and the first notification unit.

17. A static elimination apparatus that performs static elimination of a sheet on which an image is formed by an image formation apparatus, the static elimination apparatus comprising:
a conveyance unit configured to convey the sheet;
a static elimination unit configured to perform the static elimination of the sheet conveyed by the conveyance unit; and
a signal transmission unit configured to transmit a certain signal to the image formation apparatus based on a state of the static elimination unit.

18. An image formation apparatus that discharges a sheet on which an image is formed to a static elimination apparatus including a static elimination unit for the sheet, the image formation apparatus comprising:
a signal reception unit configured to receive a certain signal based on a state of the static elimination unit from the static elimination apparatus; and
a notification unit configured to indicate content of notification corresponding to the signal received by the signal reception unit.

19. A non-transitory computer-readable storage medium storing executable instructions, which when executed by one or more processors of an image formation system cause the image formation system to perform a control method, the image formation system including an image formation apparatus and a static elimination apparatus including a static elimination unit for a sheet on which an image is formed by the image formation apparatus, the control method comprising:
causing the static elimination apparatus to transmit a certain signal to the image formation apparatus based on a state of the static elimination unit; and
causing the image formation apparatus to indicate content of notification corresponding to a signal received from the static elimination unit.
